(19) United States
(12) Patent Application Publication
(10) Pub. No.: US 2005/0029082 A1
(43) Pub. Date: Feb. 10, 2005

(54) Corrosion-resistant switching mechanism

(76) Inventor: Ibrahim Ibrahim, North Ryde (AU)

Correspondence Address: JAGTIANI + GUTTAG, 10363-A DEMOCRACY LANE, FAIRFAX, VA, 22030, US

(21) Appl. No.: 10/910,590

(22) Filed: Aug. 4, 2004

(30) Foreign Application Priority Data
Aug. 7, 2003 (AU) 2003904139

(51) Int. Cl. H01H 29/16

(52) U.S. Cl. 200/200

(57) ABSTRACT

In one embodiment, a corrosion-resistant switching mechanism for enabling a user to control an internal signal of an electronic device id disclosed. The switching mechanism comprises: an environmentally-exposed, manually-adjustable switch having an input and a switched output; a first component configured to provide an AC signal to input of said manually-adjustable switch; and an environmentally-isolated second component to control the internal signal in response to receipt of the AC signal from the switched output.

### CROSS-REFERENCE TO RELATED APPLICATIONS

This application claims the priority of Australian Patent No. 20030904139, filed Aug. 7, 2003. The entire disclosure and contents of the above application is hereby incorporated by reference herein.

This application is related to U.S. Pat. Nos. 4,532,930, 6,537,200, 6,565,503, 6,575,894, and 6,697,674. The entire disclosure and contents of the above patents are hereby incorporated by reference herein.

### BACKGROUND

1. Field of the Invention

The present invention relates generally to switching mechanisms and, more particularly, to corrosion-resistant switching mechanisms.

2. Related Art

Switching mechanisms are provided in electronic devices to allow manual selection of various operational settings. Such settings are provided to enable a user to, for example, select features, functions of the device, to set values used by the device, etc. The exposure of such switching mechanisms to moisture can cause corrosion and/or accelerate degradation of the mechanism. In particular, moisture can have significant adverse effects on the electrical contacts within a switching mechanism.

Some switching mechanisms are more likely to become exposed to moisture, depending on the function of the device in which the switching mechanisms are implemented, and the environment in which the device is used. One example of such electronic devices are those components of medical devices which are worn by a patient (also referred to herein as a recipient). Such medical devices are designed to assist, replace, monitor or otherwise support biological systems of the recipient. Many such medical devices often include one or more sensors, processors, controllers or other functional components that are permanently or temporarily implanted in the patient. Typically, such implantable devices require the transfer of power and/or information with external components that are worn by the patient.

One particular example of a medical device having patient-worn components is a prosthetic hearing device. Prosthetic hearing devices such as hearing aids and cochlear™ implants usually include a component that is worn behind the ear of the recipient of the device. This wearable device has miniature user-operable switching mechanisms which are typically exposed to and adversely affected by moisture from, for example, perspiration, rain and humidity.

### SUMMARY

In accordance with one aspect of the present invention, a corrosion-resistant switching mechanism for enabling a user to control an internal signal of an electronic device is disclosed. The switching mechanism comprises: an environmentally-exposed, manually-adjustable switch having an input and a switched output; a first component configured to provide an AC signal to the input of said manually-adjustable switch; and an environmentally-isolated second component to control the internal signal in response to receipt of the AC signal from the switched output, wherein the AC signal does not have a DC component.

In accordance with another aspect of the present invention, an electronic device is disclosed. The device comprises: at least one electronic component; and a switching mechanism comprising at least one manually-operated switch to control operational setting of at least one electronic component, wherein the switch selectively connects to an input line and a switched output line, wherein the input line conducts only an AC signal which does not have a DC component.

In accordance with a further aspect of the present invention, a corrosion-resistant switching mechanism for use in a device is disclosed. The switching mechanism comprises: an environmentally-exposed, manually-adjustable switch having an input and a switched output; a first component configured to provide an AC signal to said input of said manually-adjustable switch; and a second component to provide to the device an internal signal in response to receipt of the AC signal from said switched output, wherein the AC signal does not have a DC component.

### BRIEF DESCRIPTION OF THE DRAWINGS

FIG. 1 is a perspective view of one embodiment of a hearing prosthesis in which embodiments of the present invention may be implemented.

FIG. 2A is a perspective view of one embodiment of the speech processor unit illustrated in FIG. 1.

FIG. 2B is a side view of the embodiment of the speech processor unit illustrated in FIG. 2A.

FIG. 2C is a bottom view of the embodiment of the speech processor unit illustrated in FIG. 2A.

FIG. 3 is a high-level functional block diagram of one embodiment of a switching mechanism of the present invention.

FIG. 4 is a schematic block diagram of one embodiment of a switching mechanism of the present invention.

FIG. 5 is a schematic block diagram of one embodiment of the detection channel component illustrated in FIG. 3.

FIG. 6 is a functional block diagram of another embodiment of a switching mechanism of the present invention.

### DETAILED DESCRIPTION

Embodiments of the present invention are directed to switching mechanisms which are substantially resistant to corrosion or other degradation due to exposure to moisture. Generally, a corrosion-resistant switching mechanism of the present invention switchingly conducts a balanced alternating current (AC) signal (that is, an AC signal having no direct current (DC) component) through an environmentally-exposed switch which is then used to control an internal signal that is usable by the implementing host device. The contacts of the environmentally-exposed switch, which can be a single-pole/single-throw; multi-pole/multi-throw, potentiometer or other type of switch, does not corrode or otherwise degrade with exposure to moisture due to the absence of a DC component in the switched signal. The other components of the switching mechanism, which may include one or more additional switches, are not exposed to the environment and, therefore, may utilize AC signals having a DC component, or DC signals, without risk of corrosion. The switching mechanism of the present invention is particularly beneficial for use in electronic devices implementing switches which are exposed to the environment to enable a person to control operational settings in the device.

Embodiments of the present invention are described below in connection with one type of electronic device, a speech processor unit of a prosthetic hearing device (also referred to as a cochlear™ prosthesis, cochlear™ implant system, cochlear™ prosthetic device and the like). Prosthetic hearing devices use direct electrical stimulation of auditory nerve cells to bypass absent or defective hair cells that normally transduce acoustic vibrations into neural activity. Such devices generally use multi-contact electrodes inserted into the scala tympani of the cochlea so that the electrodes may differentially activate auditory neurons that normally encode differential pitches of sound. Such devices are also used to treat a smaller number of patients with bilateral degeneration of the auditory nerve. For such patients, a prosthetic hearing device provides stimulation of the cochlear nucleus in the brainstem.

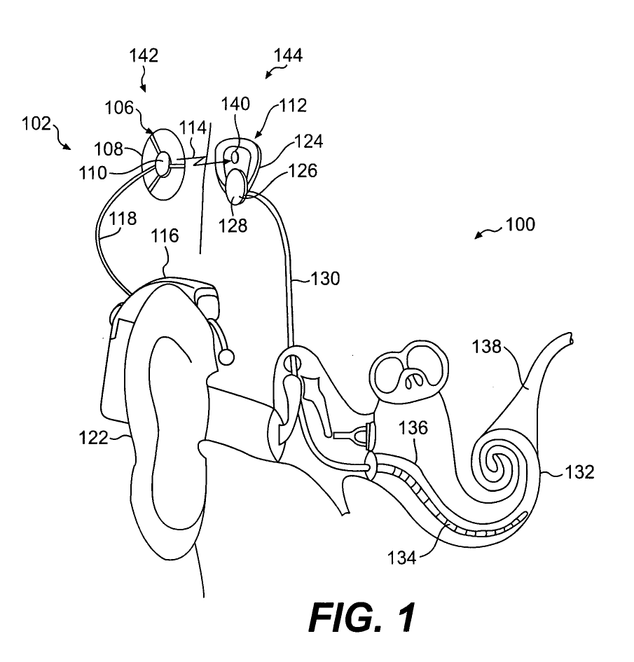

Exemplary cochlear™ implant systems in which the present invention may be implemented include, but are not limited to, those systems described in U.S. Pat. Nos. 4,532,930, 6,537,200, 6,565,503, 6,575,894 and 6,697,674, which are hereby incorporated by reference herein. FIG. 1 is a schematic diagram of an exemplary cochlear™ implant system 100 in which embodiments of the present invention may be implemented. Cochlear™ implant system 100 comprises external component assembly 142 which is directly or indirectly attached to the body of the recipient, and an internal component assembly 144 which is temporarily or permanently implanted in the recipient. External assembly 142 typically comprises audio pickup devices (not shown) for detecting sounds, a speech processor unit 116 that converts the detected sounds into a coded signal, a power source (not shown), and an external transmitter unit 106. External transmitter unit 106 comprises an external coil 108, and, preferably, a magnet 110 secured directly or indirectly to external coil 108. Speech processor unit 116 processes the output of the audio pickup devices that may be positioned, for example, by the ear 122 of the recipient. Speech processor unit 116 generates stimulation signals which are provided to external transmitter unit 106 via cable 118.

Internal component assembly 144 comprises an internal receiver unit 112, a stimulator unit 126, and an electrode array 134. Internal receiver unit 112 comprises an internal receiver coil 124 and a magnet 140 fixed relative to internal coil 124. Internal receiver unit 112 and stimulator unit 126 are hermetically sealed within a housing 128. Internal coil 124 receives power and data from transmitter coil 108. A cable 130 extends from stimulator unit 126 to cochlea 132 and terminates in an electrode array 134. The received signals are applied by array 134 to the basilar membrane 136 thereby stimulating the auditory nerve 138.

Collectively, transmitter antenna coil 108 (or more generally, external coil 108) and receiver antenna coil 124 (or more generally, internal coil 124) form an inductively-coupled coil system of a transcutaneous transfer apparatus 102. Transmitter antenna coil 108 transmits electrical signals to the implantable receiver coil 124 via a radio frequency (RF) link 114. Internal coil 124 is typically a wire antenna coil comprised of at least one and preferably multiple turns of electrically insulated single-strand or multi-strand platinum or gold wire. The electrical insulation of internal coil 124 is provided by a flexible silicone molding (not shown). In use, implantable receiver unit 112 may be positioned in a recess of the temporal bone adjacent to ear 122 of the recipient.

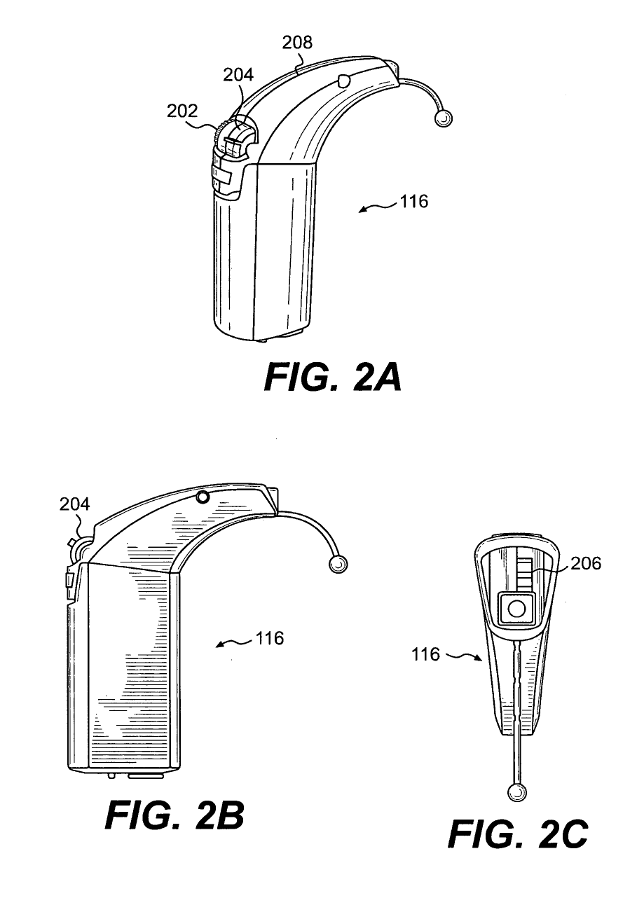

FIGS. 2A-2C are perspective views of an external speech processor unit 116 of cochlear™ implant system 100, introduced above with reference to FIG. 1. Speech processor unit 116, as noted, has a configuration to facilitate it being operationally positioned behind the ear of the recipient. As such, speech processor unit 116 is exposed to moisture from, for example, perspiration, rain and humidity.

External speech processor unit 116 comprises a variety of environmentally-exposed miniature switches 202, 204, 206 to enable the recipient of cochlear™ implant system 100 to select various operational settings. For example, a single-pole/multi-throw switch 204 is provided on a spine 208 of speech processor unit 116. In the illustrative embodiment, switch 204 is used by the recipient to select one of a number of switch positions each associated with an available speech processing program, and an “off” position which turns speech processor unit 116 off.

Similarly, the adjacent miniature switch 202 is a potentiometer switch that enables the recipient to adjust the volume and/or sensitivity of cochlear™ implant system 100. In addition, a linear, three-position miniature switch 206 is provided on the underside of speech processor unit 116, as best shown in FIG. 2C. Miniature switch 206 is provided to enable the recipient to switch between different listening situation options. The above and other operational features of a cochlear™ implant system are considered well-known to those of ordinary skill in the art and, therefore, are not described further herein.

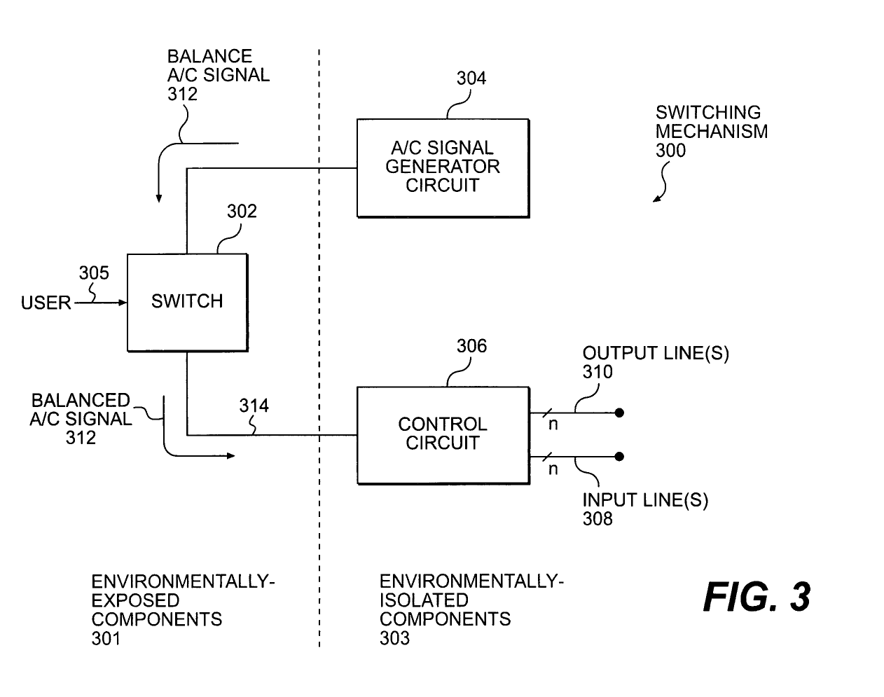

FIG. 3 is a functional block diagram of one embodiment of a switching mechanism of the present invention. Switching mechanism 300 comprises components 301 that are exposed to the environment and components 303 that are not exposed to, or isolated from, the environment. Environmentally-exposed components 301 comprise a user-operable switch 302. Switch 302 can be, as noted, a single-pole/single-throw; multi-pole/multi-throw, single-pole/multi-throw, potentiometer or other type of user-controllable switch. Environmentally-isolated components 303 comprise an alternating current (AC) signal generator circuit 304 that generates an AC signal 312 that has no direct current (DC) component.

Switch 302 switches AC signal 312 in response to the user's adjustment 305 of switch 302. Depending on the configuration of switch 302, there may be one or more switch-control lines 314 connecting switch 302 and control circuit 306. Control circuit 306 receives one or more input lines 308 from the host system, here speech processor unit 116. Each input line 308 is controllably connected to a corresponding output line 310, referred to herein as switched output line 310. Control circuit 306 connects at least one input line 308 with its corresponding switched output line 310 in response to the receipt of AC signal 312 over one switch-control line 314. Thus, by controlling switch 302, a user controls the passage of a signal on one or more input lines 308 to a corresponding one or more output lines 310.

Because switch 302 switches an AC signal 312 which does not have a DC component, the contacts of switch 302 do not readily corrode or otherwise degrade in the presence of moisture. As such, the fact that corrosion-resistant switch 302 is exposed to the external environment does not adversely affect the performance of switching mechanism 300. Also, the other components 304, 306 of switching mechanism 300, which may include one or more additional switches, are not exposed to the environment. Such components, then, may utilize and/or generate AC signals, DC signals and/or other signals without being subject to corrosion due to moisture exposure.

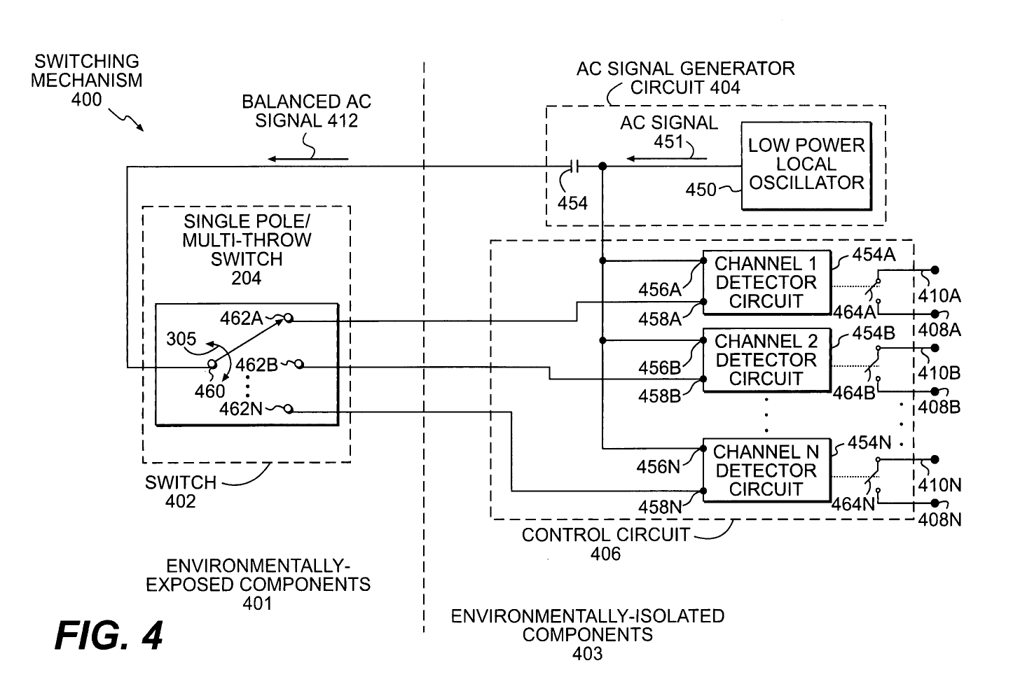

FIG. 4 is a schematic block diagram of one embodiment of a corrosion-resistant switching mechanism 400 of the present invention. This embodiment of switching mechanism 400 is implemented in speech processor unit 116 shown in FIGS. 1 and 2A-2C to provide single-pole/multi-throw switch 204. As noted, in the exemplary application introduced above, switch 204 is used by the recipient of cochlear™ implant system 100 to select which of a number of available speech processing programs is to be currently implemented in speech processor unit 116, or to turn off the unit.

Switching mechanism 400 comprises environmentally-exposed components 401 and environmentally-isolated components 403. Environmentally-exposed components 401 are subject to the incursion of moisture while environmentally-isolated components 403 are internal components which are sufficiently shielded, covered, etc., to substantially prevent intrusion of moisture.

Environmentally-exposed components 401 comprise switch 402 implementing single-pole/multi-throw switch 204. Switch 204 has a plurality of contacts comprising a common contract 460 and a plurality of switched contacts 462A-462N. In the embodiment depicted in FIG. 4, three switched contacts 462 are shown with each being connected to a channel though components 403, as described herein. User operation 305 of switch 204 causes common contact 460 to be electrically connected to a desired one of the plurality of switched contracts 462.

Environmentally-isolated components 403 comprise AC signal generator circuit 404 and a control circuit 406. AC signal generator circuit 404 generates an AC signal 412. As with AC signal 312 introduced above, AC signal 412 has no DC component. AC signal 412 is provided to environmentally-exposed components 401; that is, single-pole/multi-throw switch 204.

AC signal generator circuit 404 comprises a local oscillator 450 which generates an AC signal 451. Oscillator 450 is connected to common contact 460 of switch 402, and to control circuit 406, as described below. In this embodiment, oscillator 450 does not necessarily generate an AC signal; but may generate a square pulse signal which has a finite average (DC) value. AC signal generator circuit 404 further comprises at least one coupling capacitor 454 that filters the DC component of AC signal 451 so that AC signal 412 is balanced. As one of ordinary skill in the art would appreciate, AC signal generator circuit 404 can be implemented with a variety of different components in a corresponding variety of configurations. For example, in one alternative embodiment, the type of oscillator implemented in circuit 404 generates a pure AC signal without a DC component, thereby eliminating the need to include coupling capacitor 454.

The elimination of DC current flow at contacts 460, 462 of switch 402 improves the immunity of switch 402 against corrosion due to electrochemical etching under DC conditions when moisture is present between such contacts. In turn, this provides improved reliability and extends the longevity of switch 402 and the host electronic device, here speech processor unit 116. Another advantage of certain embodiments of the switching mechanism of the present invention is that the magnitude of AC signal 412 is not significant. This improves the mechanical reliability of switch 402 and extends its life.

Control circuit 406 comprises one or more channel detector circuits 454A-454N. In the embodiment shown in FIG. 4, the quantity of detection channel circuits 454 corresponds to the quantity of switched contacts 462A-462N of switch 402. Each detector circuit 454A-456N controls the operation of a corresponding switch 464A-464N. Each switch 464A-464N has an input line 408A-408N and a corresponding output line 410A-410N. Operation of each switch 464A-464N causes the switch to connect or disconnect its input line 408A-408N and corresponding output line 410A-410N.

As noted, control circuit 406 has an input connected to the output of local oscillator 450. In the embodiment shown in FIG. 4, this input is provided to an input 456A-456N of each channel detector circuit 454A-454N. Thus, each detector circuit 454A-454N receives at an input 456A-456N AC signal 451.

Each channel detector circuit 454A-454N also comprises a second input 458A-458N each connected to one switched contact 462A-462N of switch 402. This second input receives AC signal 412 when switch 204 is positioned such that common contact 460 is switchedly connected to the appropriate switched contact 462 in switch 402. When a detection channel 454 receives 451 at its second input 458, detection circuit 454 activates its corresponding switch 464 to connect its input and output lines 408, 410. Since only one channel detector circuit 454 can receive AC signal 412 at any given time, at most only one switch 464 is activated at any given time.

It should be appreciated that internal switches 464 can switch any type of signal traveling over lines 408 and 410 which can be utilized by speech processor unit 116. Because switches 464 are not exposed to the environment and, therefore, are not subject to the accumulation of moisture, switches 464 are not subject the corrosion due to electrochemical etching under DC conditions when moisture is present between the contacts of the switches. In other words, switching mechanism 400 comprises two switches to controllably connect lines 408 and 410. One switch which is isolated from the environment is connected to lines 408 and 410 while the other switch 402 is exposed to the environment and switches an AC signal. User manipulation of the environmentally-exposed switch 402 indirectly controls the operation of environmentally-isolated switches 464.

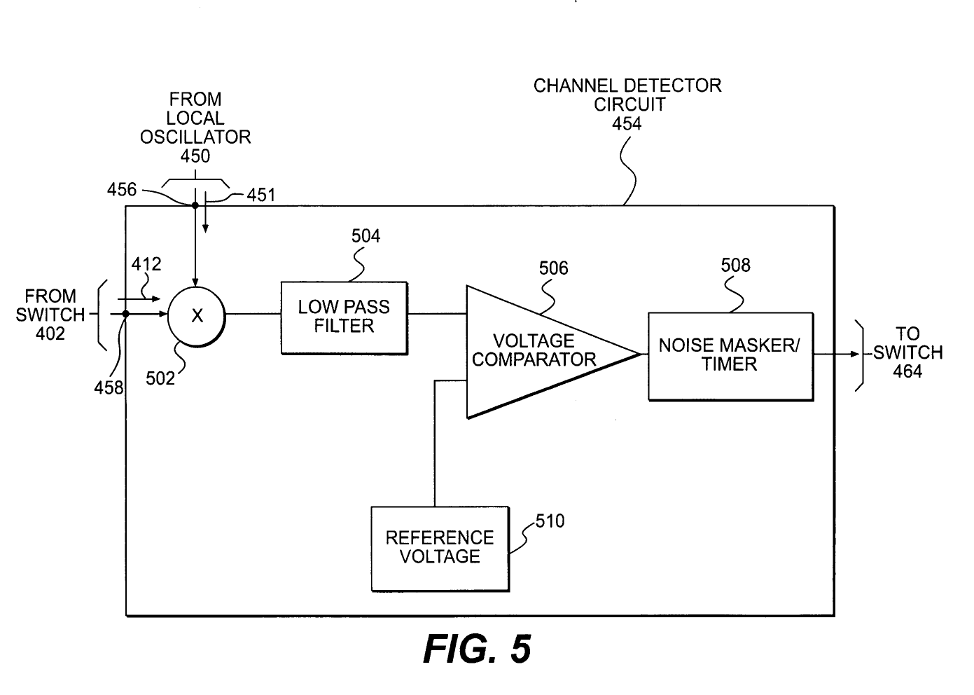

FIG. 5 is a schematic block diagram of one embodiment of a channel detector circuit 454 of FIG. 4. Each circuit 454 comprises a serially-connected arrangement of a multiplier 502, a low pass filter 504, a voltage comparator 506, and a noise filter 508, as shown. Multiplier 502 receives AC signal 412 at input 458 of circuit 454 which, as noted, is connected to the output of environmentally-exposed switch 402. Multiplier 502 also receives AC signal 451 at input 456 of circuit 454 which, as noted, is connected to the output of oscillator 450.

When circuit 454 receives AC signal 412 and AC signal 451, the output of multiplier 502 is at its maximum, since both input signals 412, 451 have the same frequency and phase. The output signal from multiplier 402 is filtered using low pass filter 504 and thereafter applied to the input of voltage comparator 506.

Voltage comparator 506 compares the filtered signal from low pass filter 504 using reference voltage 510. The output of voltage comparator 506 is gated against a reference time window generated in the noise masker/timer 508. When comparator 506 remains active for a pre-determined period of time, the output of noise masker 508 is activated and in turn, actuates corresponding electronic switch 464. This has the advantage of minimizing false switching due to noise, interference or “bouncing” of mechanical switch 402. Thus, when switch 402 is adjusted by the user such that AC signal 412 is provided to channel detector circuit 454, corresponding switch 464 is activated to connect input line 408 with switched output line 410.

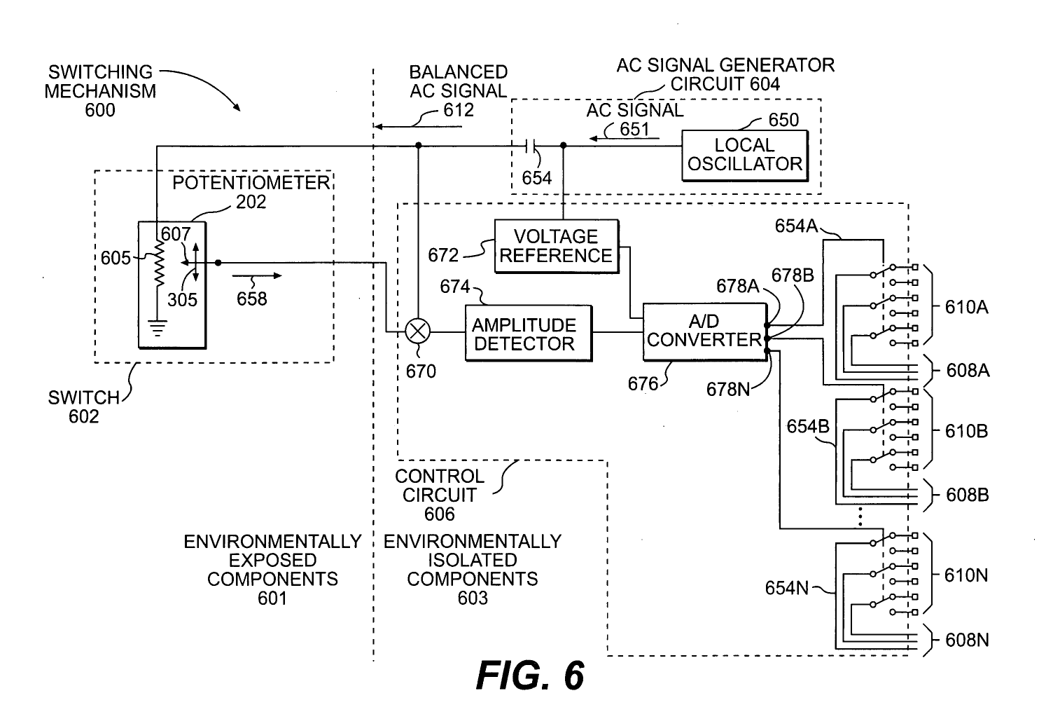

FIG. 6 is a schematic block diagram of one embodiment of a corrosion-resistant switching mechanism 600 of the present invention. This embodiment of switching mechanism 600 is implemented in speech processor unit 116 shown in FIGS. 1 and 2A-2C to provide one of the above-noted user-operable switches, potentiometer 202. As noted, potentiometer 202 is implemented in cochlear™ implant system 100 to enable the recipient to adjust the volume and/or sensitivity of the audio signal generated by system 100. One advantage of using a potentiometer as compared with a single- or multi-pole switch is that the physical construction of a potentiometer usually provides a greater seal which protects the switch from moisture ingress.

Switching mechanism 600 comprises environmentally-exposed components 601 and environmentally-isolated components 603. Environmentally-exposed components 601 comprise switch 602 implementing potentiometer switch 202. Switch 602 receives an AC signal 612 from an AC signal generator circuit 604. Switch 602 has a resistive pot 605 with a user-controllable 305 contact arm 607 which drives the output of switch 602. User operation of contact arm 607 causes a change in the magnitude of AC signal 612 which is output from switch 602. The signal generated by switch 602 is referred to as AC signal (adjusted) 658 herein.

Environmentally isolated components 603 comprise AC signal generator circuit 604 and control circuit 606. AC signal generator circuit 604 generates AC signal 612. As noted above in connection with similarly-generated AC signals, AC signal 612 is an AC signal which has no DC component. AC signal 612 is provided to environmentally-exposed components 601; in this embodiment, potentiometer switch 202, as noted above. AC signal generator circuit 604 comprises an oscillator 650 which preferably is a low-power oscillator that generates an AC signal 651. As with AC signal 451, AC signal 651 typically would have a DC component. The output of oscillator 654 is connected to the input of switch 602 through a coupling capacitor 654. Coupling capacitor 654 filters the DC component of AC signal 651 so that AC signal 612 is balanced. The output of AC signal generator circuit 604 and the output of oscillator 650 are connected to control circuit 606, as described in detail below. As with AC signal generator circuit 504, one of ordinary skill in the art would appreciate that AC signal generator circuit 604 can be implemented in a number of different ways to provide what is commonly referred to as AC signal 612.

Control circuit 606 comprises a multiplier 670 that, as noted, receives AC signal 612 directly from AC signal generator circuit 604. Multiplier 670 also receives AC signal (adjusted) 658 from switch 602. The AC signal (adjusted) 658 generated by potentiometer 202 has a peak voltage that is proportional to AC signal 612, according to a physical position of potentiometer 202. Multiplier 670 multiplies AC signal (adjusted) 658 from potentiometer 202 with AC signal 612 generated by AC signal generator circuit 604. As with the multiplier described herein with reference to the embodiment shown in FIG. 4, multiplier 670 effectively cancels noise appearing in AC signal 612 because signals 612 and 658 have matching frequency and phase.

The signal generated by multiplier 670 has a DC component which has a magnitude which depends on the amplitude of AC signal 651. This signal is applied to an amplitude detector 674 which restores the signal into a DC analog signal which can then be applied as the first of two input signals to an analog-to-digital (A/D) converter 676.

A/D converter 676 also receives a reference voltage from voltage reference block 672. A DC reference voltage signal is generated by block 672 based on AC signal 651 received from local oscillator 650. The DC signal generated by voltage reference 672 has a voltage that matches a full-scale-voltage range of A/D converter 676. It should be appreciated that the use of a reference voltage derived from the same source signal causes a cancellation of unwanted signals and noise, thereby reducing the adverse effects of interference and insuring accuracy of control circuit 606.

The output of A/D converter 676 generates a digital code that represents the position of contract arm 607 along pot 605 of potentiometer 202. Each one or more bits of the digital rives an output line 678A-678N of A/D converter 676. Thus, A/D converter 676 es in response to the two DC input signals by activating one of a plurality of outputs, 678N, depending on the position of potentiometer 202. Each output 678 in turn activates a particular one of switching banks 654A-654N. A/D converter 676 preferably also includes hysteresis circuitry to minimize output instability.

Each output 678 of A/D converter 676 is connected to and controls the operation of one of the plurality of switching banks 654A-654N. Each switching bank 654 has a plurality of input lines 608 and a corresponding plurality of switched output lines 610. When A/D converter 676 activates a switch 654, all input lines 608 of that switch are connected to their corresponding output lines 610.

Thus, of the switch bank 654 is activated at any given time depends on the position of potentiometer switch 202. The one or more signals switchingly controlled by switch banks 654 are internal signals usable by host implant device 100.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A corrosion-resistant switching mechanism for enabling a user to control an internal signal of an electronic device, comprising:
an environmentally-exposed, manually-adjustable switch having an input and a switched output;
a first component configured to provide an AC signal to said input of said manually-adjustable switch; and
an environmentally-isolated second component to control an internal signal in response to receipt of said AC signal from said switched output, wherein the AC signal does not have a DC component.

2. The switching mechanism of claim 1, wherein said internal signal comprises one of a group consisting of:
a DC signal; and
an AC signal with a DC component.

3. The switching mechanism of claim 1, wherein said electronic device is a speech processor unit of a prosthetic hearing device.

4. The switching mechanism of claim 1, wherein said electronic device is a component of a medical device which is worn on a patient's body.

5. The switching mechanism of claim 1, wherein said switch is a miniature switch.

6. The switching mechanism of claim 1, wherein said switch comprises one or more of a group consisting of:
a single-pole/single-throw switch;
a single-pole/multi-throw switch;
a multi-pole/single-throw switch;
a potentiometer switch; and
a linear, multi-position switch.

7. The switching mechanism of claim 1, wherein said switching mechanism further comprises:
an AC signal generator circuit that generates said AC signal.

8. The switching mechanism of claim 1, wherein said AC signal generator circuit is environmentally-isolated.

9. The switching mechanism of claim 7, wherein said AC signal generator circuit comprises:
an oscillator that generates an AC signal.

10. The switching mechanism of claim 9, wherein said AC signal has a DC component, and further wherein said AC signal generator circuit further comprises:
a coupling capacitor that filters said DC component of said AC signal to generate said AC signal.

11. The switching mechanism of claim 1, wherein said environmentally isolated components comprise:
a plurality of switch assemblies, each having at least one input line and at least one output line, wherein each of said at least one output line corresponds to a respective one of said at least one input line, wherein said internal signal is received on each said input line; and
a control circuit for activating one of said plurality of switch assemblies in response to receipt of said AC signal from said environmentally-exposed switch.

12. The switching mechanism of claim 11, wherein said environmentally-exposed switch is a single-pole/multi-throw switch having a single input contact and a plurality of switched contacts, and wherein said control circuit comprises:
a plurality of channel detector circuits each connected to a respective one of said switched contacts, wherein each of said channel detector circuits controls an associated one of said plurality of switch assemblies, activating said associated switch assembly when said respective channel detector circuit receives said AC signal from said environmentally-exposed switch.

13. The switching mechanism of claim 11, wherein said environmentally-exposed switch comprises a potentiometer switch that receives said AC signal from an AC signal generator circuit and having an adjustable arm, the position of which determines a magnitude of said AC signal provided at said output of said potentiometer, and wherein said AC signal generator circuit comprises:
a control circuit having a plurality of output lines each connected to said input of a respective said switch assemblies, wherein said control circuit drives one of said output lines to activate one of said switch assemblies based on a position of said adjustable arm of said potentiometer.

14. The device of claim 11, wherein one or more of said plurality of switch assemblies comprise one of a group consisting of:
a single-pole/single-throw switch;
a single-pole/multi-throw switch;
a multi-pole/single-throw switch; and
a linear, multi-position switch.

15. An electronic device comprising:
at least one electronic component; and
a switching mechanism comprising at least one manually-operated switch to control an operational setting of said at least one electronic component, wherein said switch selectively connects to an input line and a switched output line, wherein said input line conducts only a AC signal, wherein the AC signal does not have a DC component.

16. The device of claim 15, wherein said device is a speech processor unit of a prosthetic hearing device.

17. The device of claim 15, wherein said device is a component of a medical device which is worn on a patient's body.

18. The device of claim 15, wherein said manually-operated switch is a miniature switch.

19. The device of claim 15, wherein said manually-operated switch comprises one or more of a group consisting of:
a single-pole/single-throw switch;
a single-pole/multi-throw switch;
a multi-pole/single-throw switch;
a potentiometer switch; and
a linear, multi-position switch.

20. The device of claim 15, wherein said switching mechanism further comprises:
an AC signal generator circuit that generates said AC signal.

21. The device of claim 15, wherein said AC signal generator circuit comprises:
an oscillator that generates an AC signal; and
a coupling capacitor that filters any DC component of said AC signal to generate said AC signal.

22. The device of claim 15, wherein said environmentally isolated components comprise:
a plurality of switch assemblies, each having at least one input line and at least one output line, wherein each of said at least one output line corresponds to a respective one of said at least one input line, wherein said internal signal is received on each said input line; and
a control circuit for activating one of said plurality of switch assemblies in response to receipt of said AC signal from said manually-operated switch.

23. The device of claim 22, wherein said manually-operated switch is a single-pole/multi-throw switch having a single input contact and a plurality of switched contacts, and wherein said control circuit comprises:
a plurality of channel detector circuits each connected to a respective one of said switched contacts, wherein each of said channel detector circuits controls an associated one of said plurality of switch assemblies, activating said associated switch assembly when said respective channel detector circuit receives said AC signal from said manually-operated switch.

24. The device of claim 22, wherein said environmentally-exposed switch comprises a potentiometer switch that receives said AC signal from an AC signal generator circuit and having an adjustable arm, the position of which determines a magnitude of said AC signal provided at said output of said potentiometer, and wherein said AC signal generator circuit comprises:
a control circuit having a plurality of output lines each connected to said input of a respective said switch assemblies, wherein said control circuit drives one of said output lines to activate one of said switch assemblies based on a position of said adjustable arm of said potentiometer.

25. A corrosion-resistant switching mechanism for use in a device comprising:
an environmentally-exposed, manually-adjustable switch having an input and a switched output;
a first component configured to provide an AC signal to said input of said manually-adjustable switch; and
a second component to provide to said device an internal signal in response to receipt of said AC signal from said switched output, wherein the AC signal does not have a DC component.

26. The mechanism of claim 25, wherein said switch comprises one or more of a group consisting of:
a single-pole/single-throw switch;
a single-pole/multi-throw switch;
a multi-pole/single-throw switch;
a potentiometer switch; and
a linear, multi-position switch.

27. The mechanism of claim 25, wherein said first component comprises:
an oscillator that generates an AC signal; and
a coupling capacitor that filters any DC component of said AC signal to generate said AC signal.

28. The mechanism of claim 25, wherein said second component comprises:
a plurality of switch assemblies, each having at least one input line and at least one output line, wherein each of said at least one output line corresponds to a respective one of said at least one input line, wherein said internal signal is received on each said input line; and
a control circuit for activating one of said plurality of switch assemblies in response to receipt of said AC signal from said manually-operated switch.

29. The mechanism of claim 28, wherein said manually-operated switch is a single-pole/multi-throw switch having a single input contact and a plurality of switched contacts, and wherein said control circuit comprises:
a plurality of channel detector circuits each connected to a respective one of said switched contacts, wherein each of said channel detector circuits controls an associated one of said plurality of switch assemblies, activating said associated switch assembly when said respective channel detector circuit receives said AC signal from said manually-operated switch.

30. The mechanism of claim 28, wherein said environmentally-exposed switch comprises a potentiometer switch that receives said AC signal from an AC signal generator circuit and having an adjustable arm, the position of which determines a magnitude of said AC signal provided at said output of said potentiometer, and wherein said AC signal generator circuit comprises:
a control circuit having a plurality of output lines each connected to said input of a respective said switch assemblies, wherein said control circuit drives one of said output lines to activate one of said switch assemblies based on a position of said adjustable arm of said potentiometer.

31. The mechanism of claim 25, wherein said device is a speech processor unit of a prosthetic hearing device.

32. The mechanism of claim 25, wherein said device is a component of a medical device which is worn on a patient's body.

33. The mechanism of claim 25, wherein said manually-operated switch is a miniature switch.
